(19) United States
(12) Patent Application Publication
(10) Pub. No.: US 2026/0298653 A1
(43) Pub. Date: Oct. 1, 2026

(54) TRAVELING ROUTE DISPLAY METHOD AND INFORMATION SERVICE SYSTEM

(71) Applicant: HONDA MOTOR CO., LTD., Tokyo (JP)

(72) Inventor: Andrii PYDIN, Saitama (JP)

(21) Appl. No.: 19/529,147

(22) Filed: Feb. 4, 2026

(30) Foreign Application Priority Data
Mar. 28, 2025 (JP) 2025-055573

(51) Int. Cl. G01C 21/36; G01C 21/00

(52) U.S. Cl. CPC G01C 21/3667; G01C 21/3837; G01C 21/3859

(57) ABSTRACT

The method includes a first step (T1) of generating a traveling route map (M1) including a node (N) and an edge (E), a second step (T2) of an information collector (21) collecting environmental information acquired using an external sensor attached to an autonomous mobile object (1), a third step (T3) of generating an environmental information map (M2, M3, M4) from which the environmental information is visually recognizable, a fourth step (T4) of superimposing at least one environmental information map (M2, M3, M4) on the traveling route map (M1) to generate a synthetic map (MG) from which a weight set for the edge (E) according to the level of the environmental information is visually recognizable, and a fifth step (T5) of a display (4) displaying the synthetic map (MG).

This application is based on and claims the benefit of priority from Japanese Patent Application No. 2025-055573, filed on 28 Mar. 2025, the content of which is incorporated herein by reference.

### BACKGROUND OF THE INVENTION

### Field Of The Invention

The present invention relates to a traveling route display method and an information service system, and particularly relates to a traveling route display method and an information service system capable of optimizing selection of a traveling route of an autonomous mobile object.

### Related Art

In recent years, an autonomous work vehicle (AWV) as an autonomous mobile object that autonomously travels within a work area to deliver or the like a package has been developed. The autonomous mobile object selects an optimal traveling route from a plurality of traveling routes within the work area, and autonomously travels using position information from a global navigation satellite system (GNSS), a video from a camera, obstacle detection by a radar using a radio wave with a long wavelength or LiDAR using light with a short wavelength, other sensors, or the like.

Japanese Unexamined Patent Application, Publication No. H9-101169 discloses a navigation device mounted on an automobile that travels on an ordinary road, in which a weight is set for each of a plurality of traveling routes connecting a point of departure and a destination according to a traveling distance and the number of traffic lights to automatically select an optimal traveling route.

Patent Document 1: Japanese Unexamined Patent Application, Publication No. H9-101169

### SUMMARY OF THE INVENTION

Here, parameters used to perform weighting when selecting a traveling route include, for example, not only the traveling distance but also the status of congestion, the status of GNSS radio waves, a road surface condition, and the like. However, with the navigation device of Japanese Unexamined Patent Application, Publication No. H9-101169, a user cannot recognize how much and which one of the parameters affect selection of the traveling route.

An object of the present invention is to solve the above-described problems of the related art and to provide a traveling route display method and an information service system allowing a user to recognize the degree of influence of each parameter on selection of a traveling route of an autonomous mobile object.

In order to achieve the above-described object, the present invention has a first characteristic in that a traveling route display method for displaying a traveling route connecting a point of departure (N1) and a destination (N7) of an autonomous mobile object (1) operated within a work area (A) includes a first step (T1) of generating, by a traveling route map generator (22), a traveling route map (M1) including a node (N) and an edge (E), a second step (T2) of collecting, by an information collector (21), at least environmental information acquired using an external sensor attached to the autonomous mobile object (1), a third step (T3) of generating, by an environmental information map generator (23), an environmental information map (M2, M3, M4) from which the environmental information is visually recognizable, a fourth step (T4) of superimposing, by a map synthesizer (26), at least one environmental information map (M2, M3, M4) on the traveling route map (M1) to generate a synthetic map (MG) from which a weight set for the edge (E) according to the level of the environmental information is visually recognizable, and a fifth step (T5) of displaying, on a display (4), the synthetic map (MG).

The present invention has a second characteristic in that the weight set for the edge (E) is arbitrarily changeable by a weight changer (5).

The present invention has a third characteristic in that the environmental information map (M2, M3, M4) includes a color representation based on shade of color.

The present invention has a fourth characteristic in that the environmental information map (M2, M3, M4) is displayed in RGB colors.

The present invention has a characteristic in that the environmental information map (M2, M3, M4) is a pixel image indicating the level of the environmental information and the traveling route display method further includes a step of converting, by a pixel processor (24), the environmental information into the pixel image.

The present invention has a fifth characteristic in that the resolution of the environmental information map (M2, M3, M4) is changeable by changing the size of a pixel forming the pixel image.

The present invention has a sixth characteristic in that the resolution of the environmental information map (M2, M3, M4) is changeable by changing the size of a pixel forming the pixel image.

The present invention has a seventh characteristic in that the weight is displayed in the form of a number on the synthetic map (MG).

The present invention has an eighth characteristic in that the display (4) and the weight changer (5) are provided in a mobile terminal (3) to be operated by a user (U).

The present invention has a ninth characteristic in that an information service system includes an information processing device(S) and a display (4) communicably connected to the information processing device (S), the display (4) is capable of displaying a traveling route connecting a point of departure (N1) and a destination (N7) of an autonomous mobile object (1) operated within a work area (A), information on the traveling route stored in the information processing device (S) and information including a physical quantity of environmental information in the work area (A) are converted into image data displayed in colors, and the image data is displayable on the display (4).

The present invention has a tenth characteristic in that the information processing device (S) sets a weight for the traveling route according to the contribution of each piece of environmental information on the traveling route, recalculates the weight according to a contribution newly input by a user according to the displayed image data, and reselects the traveling route according to the recalculated weight.

According to the first characteristic, the traveling route display method for displaying the traveling route connecting the point of departure (N1) and the destination (N7) of the autonomous mobile object (1) operated within the work area (A) includes the first step (T1) of the traveling route map generator (22) generating the traveling route map (M1) including the node (N) and the edge (E), the second step (T2) of the information collector (21) collecting the at least environmental information acquired using the external sensor attached to the autonomous mobile object (1), the third step (T3) of the environmental information map generator (23) generating the environmental information map (M2, M3, M4) from which the environmental information is visually recognizable, the fourth step (T4) of the map synthesizer (26) superimposing the at least one environmental information map (M2, M3, M4) on the traveling route map (M1) to generate the synthetic map (MG) from which the weight set for the edge (E) according to the level of the environmental information is visually recognizable, and the fifth step (T5) of the display (4) displaying the synthetic map (MG). Thus, the user can visually recognize the weight set for each edge in the traveling route map, and therefore, the user can visually recognize how much and which one of the environmental information affects selection of the traveling route.

According to the second characteristic, the weight set for the edge (E) is arbitrarily changeable by the weight changer (5). Thus, a more optimal traveling route can be selected by changing the weight for the edge depending on the situation.

According to the third characteristic, the environmental information map (M2, M3, M4) includes a color representation based on shade of color. Thus, the weight can be represented by a difference in color, the size of a colored area, a difference in shade of color, or the like, and the user can more easily recognize the magnitude of the weight set for each edge.

According to the fourth characteristic, the environmental information map (M2, M3, M4) is displayed in the RGB colors. Thus, the weight can be displayed in three primary colors of light, and therefore, the synthetic map can be clearly displayed on the display including a liquid crystal display and the like.

According to the fifth characteristic, the environmental information map (M2, M3, M4) is the pixel image indicating the level of the environmental information, and the traveling route display method further includes the step of the pixel processor (24) converting the environmental information into the pixel image. Thus, the level of the environmental information can be clearly displayed on the display including the liquid crystal display and the like.

According to the sixth characteristic, the resolution of the environmental information map (M2, M3, M4) is changeable by changing the size of the pixel forming the pixel image. Thus, a data communication speed can be increased, for example, by decreasing the resolution of the environmental information map as necessary.

According to the seventh characteristic, the weight is displayed in the form of the number on the synthetic map (MG). Thus, the weight set for the edge of the traveling route can be easily grasped.

According to the eighth characteristic, the display (4) and the weight changer (5) are provided for the mobile terminal (3) to be operated by the user (U). Thus, the user can quickly examine or check the traveling route, and the operation efficiency of the autonomous mobile object can be enhanced.

According to the ninth characteristic, the information service system includes the information processing device (S) and the display (4) communicably connected to the information processing device (S), the display (4) is capable of displaying the traveling route connecting the point of departure (N1) and the destination (N7) of the autonomous mobile object (1) operated within the work area (A), the information on the traveling route stored in the information processing device (S) and the information including the physical quantity of the environmental information in the work area (A) are converted into the image data displayed in colors, and the image data is displayable on the display (4). Thus, the user can visually recognize the weight set for the traveling route, and therefore, the user can visually recognize how much and which one of the environmental information affects selection of the traveling route. As a result, the user can grasp a causal relationship between the traveling route selection result and the environmental information, and can use such a relationship as a material for consideration taken for selecting a traveling route with a higher operation efficiency.

According to the tenth characteristic, the information processing device (S) sets the weight for the traveling route according to the contribution of each piece of environmental information on the traveling route, recalculates the weight according to the contribution newly input by the user according to the displayed image data, and reselects the traveling route according to the recalculated weight. Thus, the user can quickly change the traveling route, and the operation efficiency of the autonomous mobile object can be enhanced.

### BRIEF DESCRIPTION OF THE DRAWINGS

FIG. 1 is a schematic diagram showing a control configuration of an autonomous mobile object;

FIG. 2 is a schematic diagram showing a traveling route of the autonomous mobile object;

FIG. 3 is a block diagram showing the configurations of a controller and peripheral equipment thereof;

FIG. 4 is a traveling route map indicating two traveling routes;

FIG. 5 is an environmental information map indicating stoppage time information;

FIG. 6 is an environmental information map indicating obstacle information;

FIG. 7 is an environmental information map indicating GNSS radio wave reception information;

FIG. 8 is an environmental information map indicating road surface information;

FIG. 9 is a conceptual diagram showing a method for generating a synthetic map;

FIG. 10 is a flowchart showing steps of a traveling route display method according to the present invention;

FIG. 11 is a flowchart showing detailed steps of the traveling route display method;

FIG. 12 is a flowchart showing steps of optimizing the traveling route:

FIG. 13 is a schematic diagram showing steps of converting the traveling route map into a pixel image;

FIG. 14 is one example of the pixel image on which the environmental information maps are superimposed;

FIG. 15 is a conceptual diagram showing a computing method for obtaining a weight for an edge extending over four pixels; and

FIG. 16 is a schematic diagram showing a modification of the synthetic map.

### DETAILED DESCRIPTION OF THE INVENTION

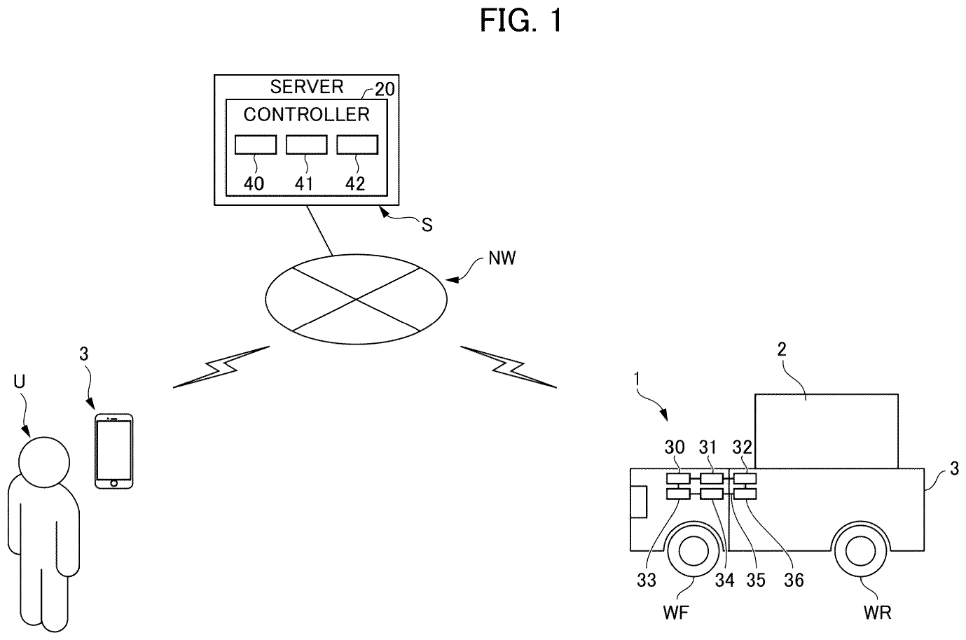

Hereinafter, a preferred embodiment of the present invention will be described in detail with reference to the drawings. FIG. 1 is a schematic diagram showing a control configuration of an autonomous mobile object 1. The autonomous mobile object 1 is an autonomous work vehicle (AWV) that autonomously travels within a work area to deliver a package 2, and for example, is a work machine that delivers a package or a material at a construction site for a massive photovoltaic power plant or a predetermined work site such as a farm or a harbor. The autonomous traveling is traveling without human operation. The autonomous traveling includes traveling under the control of an external device (for example, server S) communicable with the autonomous mobile object 1. A traveling route of the autonomous mobile object 1 is set by a controller 20 stored in the server S, and is transmitted to the autonomous mobile object 1 by wireless communication via a network NW. A sensor that acquires various types of external information is applied to the autonomous mobile object 1. Specifically, the autonomous mobile object 1 autonomously travels along the set traveling route using position information obtained by a global navigation satellite system (GNSS), a video from a camera, a radar using a radio wave with a long wavelength, light detection and ranging (LiDAR) using light with a short wavelength, other sensors, or the like. The autonomous mobile object 1 may be, for example, an autonomous mobile delivery cart.

The autonomous mobile object 1 according to the present embodiment includes a vehicle body 3 having a carrier on which a package and the like can be loaded, a pair of left and right front wheels WF provided at a lower portion of the vehicle body 3 on the front side thereof, a pair of left and right rear wheels WR provided at the lower portion of the vehicle body 3 on the rear side thereof, and a GNSS antenna 30 functioning as a receiver that receives a signal (GNSS signal) from a positioning satellite of the GNSS.

Some or all of the front wheels WF and the rear wheels WR function as drive wheels to be driven by a drive source such as a motor. Moreover, some or all of the front wheels WF and the rear wheels WR also function as steerable wheels for changing the direction of the autonomous mobile object 1. The number of front wheels WF and rear wheels WR is not limited to four, and for example, may be three, six, or the like. A traveling method using a caterpillar or the like other than wheels may be employed.

The autonomous mobile object 1 includes a processor 31, a memory 32, a movement mechanism 33, various sensors 34 required for the autonomous traveling, and a wireless communication interface 36. The processor 31, the memory 32, the GNSS receiver 30, the movement mechanism 33, various sensors 34, and the wireless communication interface 36 are communicably connected to each other, for example, via a bus 35. The movement mechanism 33 may include a power source such as a motor, a power transmission mechanism, a steering mechanism, a brake device, and the like.

Various sensors 34 include, for example, a vehicle sensor that acquires information on the autonomous mobile object 1, and an external sensor that acquires information on the periphery of the autonomous mobile object 1, and output the information acquired by each sensor to the processor 31. The information acquired by various sensors 34 may be transmitted to the external device such as the server S via the wireless communication interface 36.

Examples of the vehicle sensor may include, for example, an acceleration sensor that detects the acceleration of the vehicle body 3, a wheel speed sensor that detects the rotational speed of the front wheels WF and the rear wheels WR, and the like. Examples of the acceleration sensor may include, for example, an inertial measurement unit (IMU), a gyro sensor, and the like.

Examples of the external sensor may include, for example, a camera, LiDAR, a radar, a sonar, and the like. Here, the camera is, for example, a digital camera using an imaging element such as a charge coupled device (CCD) or a complementary metal oxide semiconductor (CMOS), and outputs, to the processor 31, image data obtained by imaging the periphery of the autonomous mobile object 1.

Using a mobile terminal 3 connected to the network NW via wireless communication, a user U who manages operation of the autonomous mobile object 1 can visually recognize the operation status and the like of the autonomous mobile object 1, and can make various instructions to the controller stored in the server S. The mobile terminal 3 is an arbitrary electronic device, and for example, a smartphone, a tablet, a mobile phone, a desktop personal computer, a laptop personal computer, or the like.

The processor 31 is an arbitrary computing device such as a central processing unit (CPU) or a micro processing unit (MPU). The processor 31 operates according to a program prepared in advance, thereby implementing various functions. The memory 32 is a storage device including a semiconductor storage medium such as an SSD, a RAM, or a ROM and a recording medium such as an HDD, a magnetic disk, or a CD-ROM. The memory 32 may be an arbitrary transitory readable storage medium or an arbitrary non-transitory readable recording medium. The memory 32 stores a computer program to be used for commanding operation of the processor 31 above and various types of data such as threshold data to be used in the processing of the processor 31. The computer program or the data may be delivered from other devices during operation of the processor 31, stored in the memory 32, and used as necessary for the processing of the processor 31. The wireless communication interface 36 is an interface for connection with a wide area communication network such as the Internet or the like.

The server S is connected to the network NW. The network NW includes, for example, one or more of the Internet, a cellular network, a Wi-Fi network, a wide area network (WAN), a local area network (LAN), or the like. The server S receives environmental information from the autonomous mobile object 1 via the network NW, and based on such information, determines the state of the autonomous mobile object 1.

The server S stores the controller 20. The controller 20 includes a processor 40, a memory 41, and a communicator 42. The processor 40 is an arbitrary computing device such as a CPU or an MPU. The processor 40 operates according to a program prepared in advance, thereby implementing various functions. The memory 41 is a storage device including a semiconductor storage medium such as an SSD, a RAM, or a ROM and a recording medium such as an HDD, a magnetic disk, or a CD-ROM. The memory 41 may be an arbitrary transitory readable storage medium or an arbitrary non-transitory readable recording medium. The memory 41 stores a computer program to be used for commanding operation of the processor 40 and various types of data such as threshold data to be used in the processing of the processor 40.

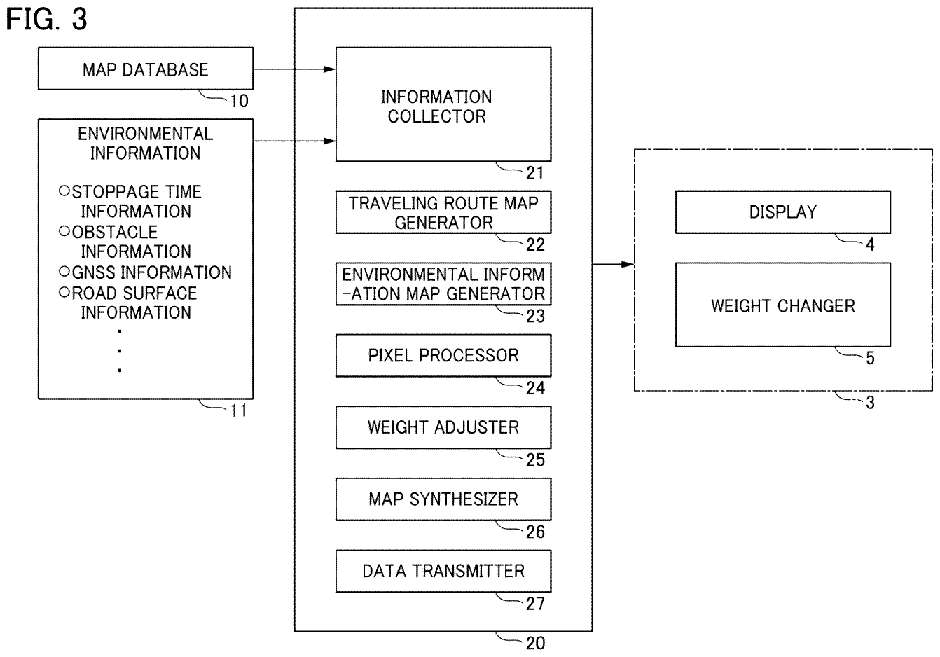

The computer program or the data may be delivered from other devices during operation of the processor 40, stored in the memory 41, and used as necessary for the processing of the processor 40. The processor 40 implements an information collector 21, a traveling route map generator 22, an environmental information map generator 23, a pixel processor 24, a weight adjuster 25, and a map synthesizer 26 described later with reference to FIG. 3. The communicator 42 implements a data transmitter 27. The memory 41 can store a map and the like generated by the processor 40.

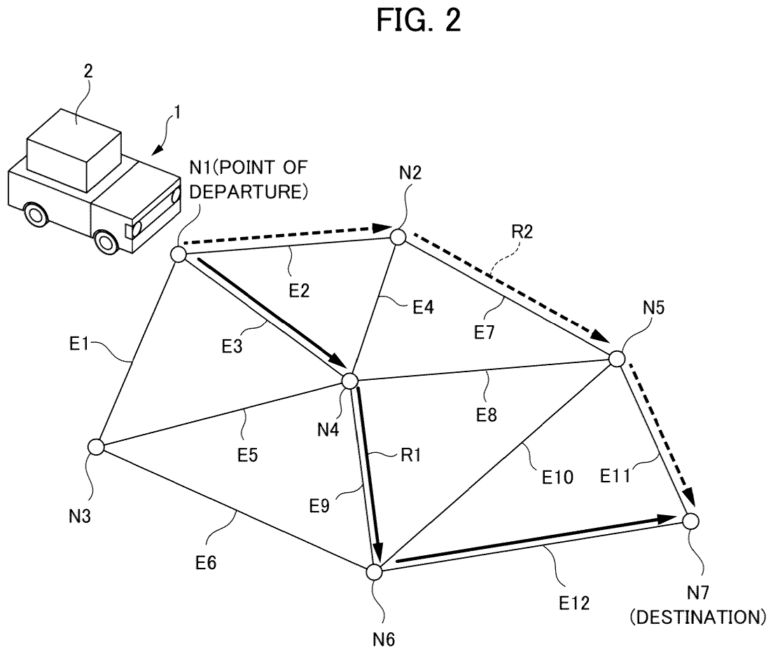

FIG. 2 is a schematic diagram showing the traveling route of the autonomous mobile object 1. Within the work area, a plurality of traveling routes connecting a point of departure and a destination is provided. The controller stored in the server S automatically selects the traveling route along which the autonomous mobile object 1 travels according not only to a traveling distance from the point of departure to the destination, but also to the environmental information such as a stoppage time due to congestion caused when a plurality of autonomous mobile objects 1 simultaneously travels, an obstacle within the work area, the status of reception of the GNSS radio wave, and a road surface condition.

In the present embodiment, the plurality of traveling routes connecting the point of departure (node N1) and the destination (node N7) is represented by seven nodes N1 to N7 and 12 edges E1 to E12. According to at least one piece of environmental information, the controller selects one traveling route along which the autonomous mobile object 1 actually travels from the plurality of traveling routes.

Here, in a conventional traveling route display method, only a selected traveling route is displayed as a result, and a user cannot recognize how much and which one of the environmental information affects the result upon selection of the traveling route. Thus, there is the following problem: although, for example, a traveling route R2 passing through the edges E2, E7, E11 in this order is shorter in traveling distance than a traveling route R1 passing through the edges E3, E9, E12 in this order, if the traveling route R1 is selected, the user U who manages operation of the autonomous mobile object 1 cannot find out the reason for such selection. On the other hand, the traveling route display method according to the present invention is characterized in that the user U can visually recognize how much and which one of the environmental information affects selection of the traveling route.

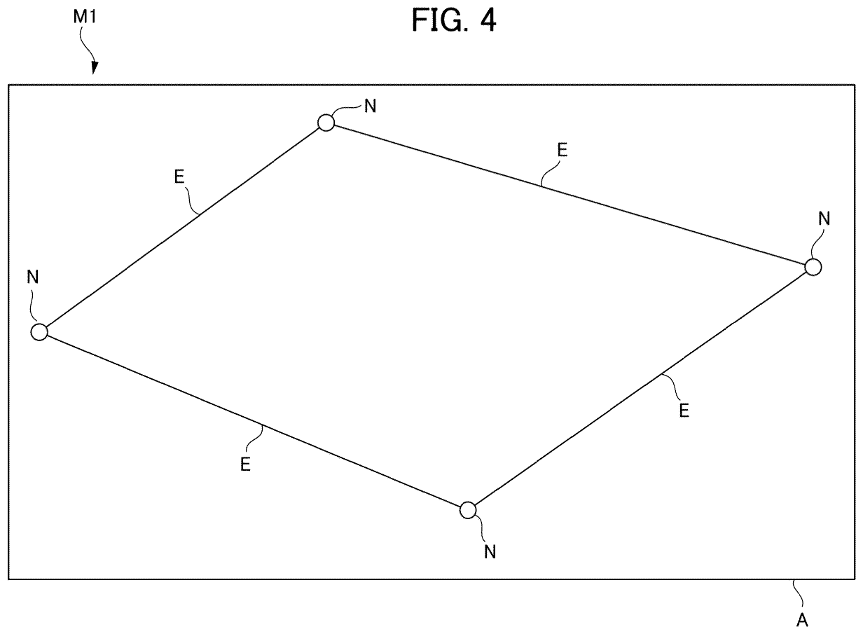

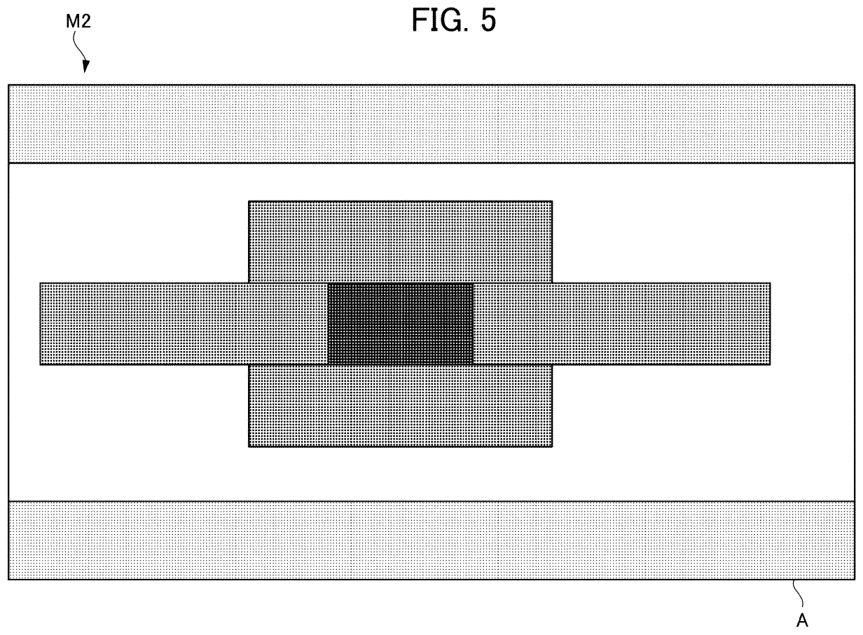

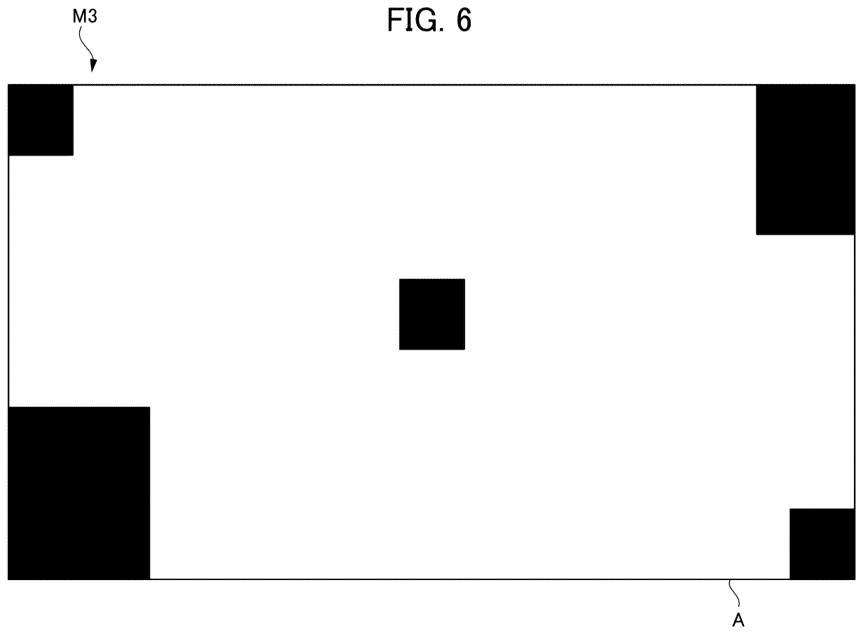

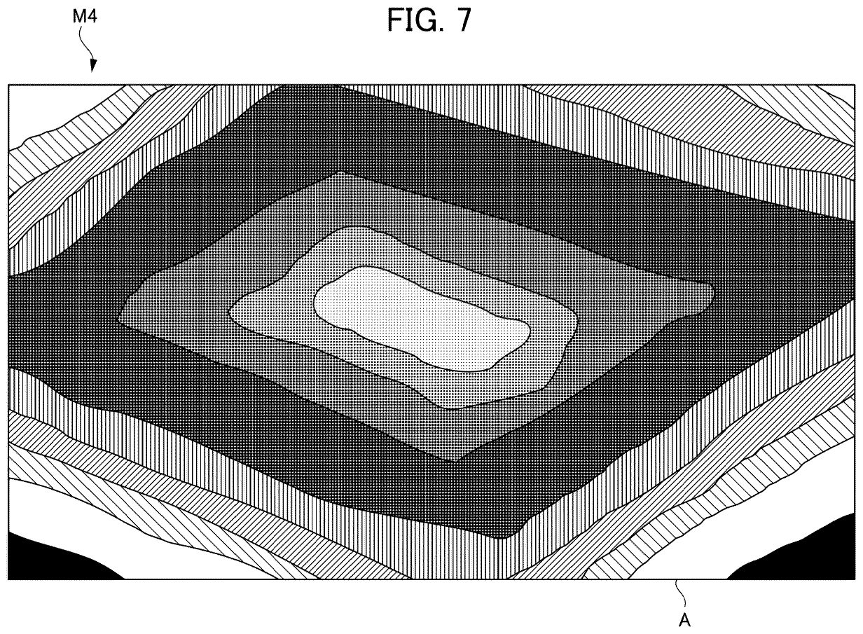

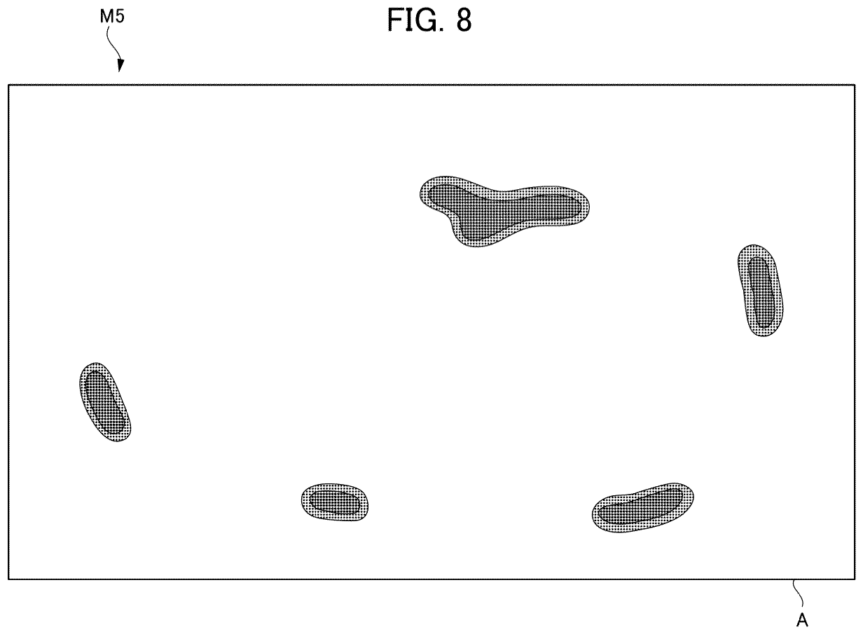

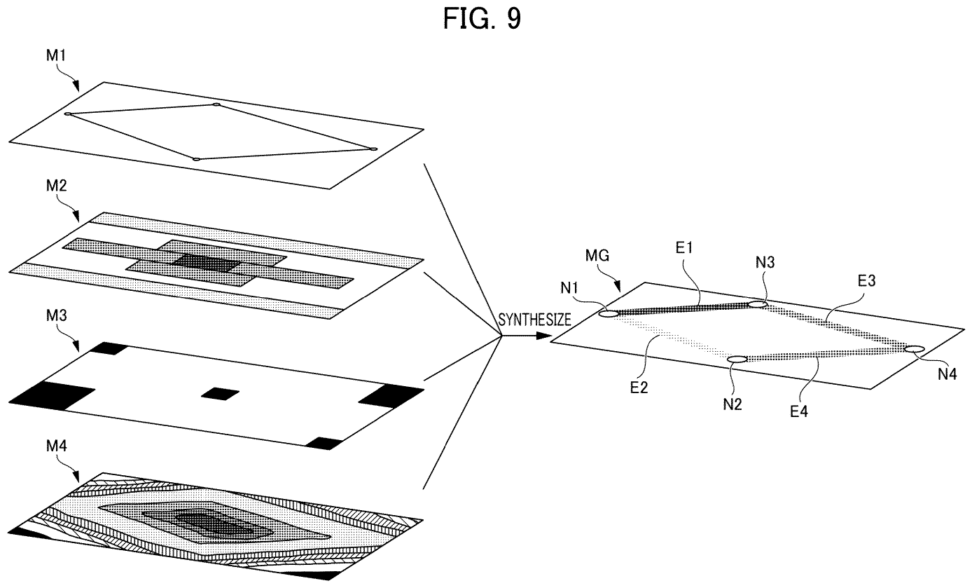

FIG. 3 is a block diagram showing the configurations of the controller 20 and peripheral equipment thereof. FIG. 4 is a traveling route map M1 indicating two traveling routes, FIG. 5 is an environmental information map M2 indicating stoppage time information, and FIG. 6 is an environmental information map M3 indicating obstacle information. FIG. 7 is an environmental information map M4 indicating GNSS radio wave reception information, FIG. 8 is an environmental information map M5 indicating road surface information, and FIG. 9 is a conceptual diagram showing a method for generating a synthetic map MG. The same reference numerals as those described above denote the same or equivalent elements. The controller 20 stored in the server S includes the information collector 21, the traveling route map generator 22, the environmental information map generator 23, the pixel processor 24, the weight adjuster 25, the map synthesizer 26, and the data transmitter 27.

The information collector 21 collects map information on a work area A from a map database accessible via the network NW, and collects the environmental information detected by various sensors, the camera, and the like. The traveling route map generator 22 generates the traveling route map M1 including the nodes N and the edges E based on the information from the map database.

The pixel processor 24 converts the environmental information collected by the information collector into a pixel image indicating the level of the environmental information. The environmental information map generator 23 generates, based on the converted pixel image, the environmental information maps M2, M3, M4, M5 indicating the environmental information so that such information can be visually recognized. Each of the environmental information maps M2, M3, M4, M5 indicates a difficulty in traveling of the autonomous mobile object 1 within the work area A due to each piece of environmental information, and a weight increases as it becomes more difficult for the autonomous mobile object 1 to travel. Each of the environmental information maps M2, M3, M4, M5 is represented by RGB colors or a grayscale, and the weight can be represented by a difference in color, the size of a colored area, a difference in shade of color, or the like.

In the present embodiment, in the environmental information map M2 indicating the stoppage time information, a darker portion indicates a longer stoppage time, and such a map is generated based on a stoppage time measured by a timer. In the environmental information map M3 indicating the obstacle information, a black portion indicates that an obstacle interfering with traveling of the autonomous mobile object 1 is present, and such a map is generated based on a video from a security camera placed in the work area A or position information output from the obstacle itself. In the environmental information map M4 indicating the GNSS radio wave reception information, a darker portion indicates a better reception state, and such a map is generated based on a received signal strength indicator (RSSI: radio field intensity). In the environmental information map M5 indicating the road surface information, a darker portion indicates a worse road surface condition, and such a map is generated based on the vertical acceleration or the like of the autonomous mobile object 1 during traveling.

With reference to FIG. 3, the map synthesizer 26 superimposes at least one of the environmental information maps M2, M3, M4, M5 on the traveling route map M1, thereby generating the synthetic map MG from which the weight set for each edge E of the traveling route map M1 according to the level of the environmental information can be visually recognized. Upon generation of the synthetic map MG, the weight adjuster 25 in the controller 20 can adjust the contribution of each piece of environmental information to a level set in advance, and separately adjust the weight set for each edge E depending on the situation. The data transmitter 27 transmits the generated synthetic map MG to the mobile terminal 3.

The mobile terminal 3 is provided with a display 4 including a liquid crystal display and the like. The synthetic map MG synthesized by the map synthesizer 26 is displayed on the display 4. With this configuration, the user U can visually recognize the weight set for each edge E of the traveling route map M1, and therefore, the user U can recognize how much and which one of the environmental information affects selection of the traveling route. As a result, the user U can grasp a causal relationship between the traveling route selection result and the environmental information, and can use such a relationship as a material for consideration taken for selecting a traveling route with a higher operation efficiency.

The mobile terminal 3 is further provided with a weight changer 5 that receives input operation from the user U, and with the weight changer 5, the user U can arbitrarily change the contribution of each piece of environmental information, or separately change the weight set for the edge E. With this configuration, a more proper traveling route can be selected by changing the weight depending on the situation. As described above, the mobile terminal 3 is provided with the display 4 and the weight changer 5, so that the user U can quickly examine or change the traveling route and the operation efficiency of the autonomous mobile object can be enhanced.

In the present embodiment, the synthetic map MG to be displayed on the display 4 is formed by superimposing the environmental information maps M2, M3, M4 including the expressions by the RGB colors on the traveling route map M1. With this configuration, the magnitude of the weight can be represented by a difference in color, the size of the colored area, a difference in shade of color, or the like, and the user U can more easily recognize the magnitude of the weight set for each edge E.

The synthetic map MG shown in FIG. 9 is set such that for the edge E1 between the nodes N1 to N3, the edge E2 between the nodes N1 to N2, the edge E3 between the nodes N3 to N4, and the edge E4 between the nodes N2 to N4, the weight increases and the shade of color of the edge E becomes lighter as it becomes more difficult for the autonomous mobile object 1 to travel. The weight for each edge in this figure is E2>E4>E3>E1, and the shade of color of the edge E2 where it is most difficult for the autonomous mobile object 1 to travel, is shown the darkest.

The data (numerical value information, color expression) for displaying each map can be generated either on the server S or on the mobile terminal 3. The weight can be displayed in three primary colors of light by applying the RGB colors, and therefore, the synthetic map MG can be clearly displayed on the display 4 including the liquid crystal display and the like. Note that when the environmental information maps M2, M3, M4 are generated, in a case where a numerical value to be given to each pixel forming the pixel image is set on the server S and the color representation by the RGB colors is applied to the mobile terminal 3, the amount of data to be transmitted from the server S to the mobile terminal 3 can be reduced. In order to further reduce the amount of data to be transmitted from the server S to the mobile terminal 3, the color representation by a grayscale may be applied.

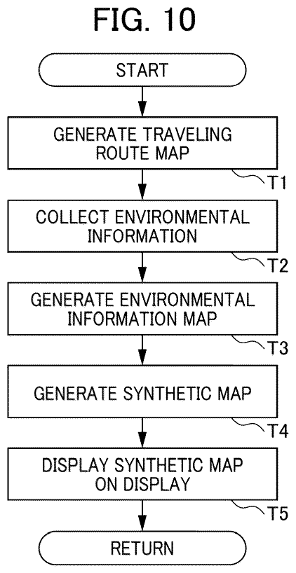

FIG. 10 is a flowchart showing the steps of the traveling route display method according to the present invention. The traveling route display method according to the present invention includes a first step T1 of the traveling route map generator 22 generating the traveling route map M1 including the nodes N and the edges E. The method further includes a second step T2 of the information collector 21 collecting at least one piece of environmental information. The method further includes a third step T3 of the environmental information map generator 23 generating the environmental information maps M2, M3, M4 from which the environmental information can be visually recognized. The method further includes a fourth step T4 of the map synthesizer 26 superimposing at least one of the environmental information maps M2, M3, M4 on the traveling route map M1 to generate the synthetic map MG from which the weight set for each edge E according to the level of the environmental information can be visually recognized. The method further includes a fifth step T5 of the display 4 displaying the synthetic map MG.

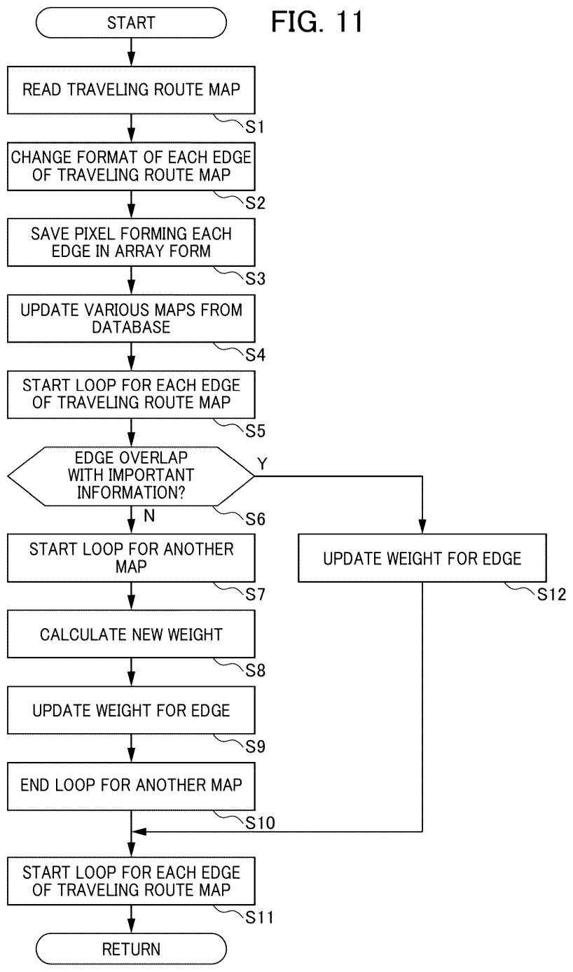

FIG. 11 is a flowchart showing detailed steps of the traveling route display method. In Step S1, the traveling route map M1 is read from a map database 10. In Step S2, format conversion is performed such that each edge E of the traveling route map M1 is converted into a pixel form. Subsequently in Step S3, the pixel forming each edge E is saved in the form of an array. In Step S4, the environmental information maps M2, M3, M4 as various maps are updated based on the environmental information stored in the database. In Step S5, a computing loop starts for each edge E of the traveling route map M1. In Step S6, it is determined whether or not any edge E overlaps with important information (obstacle) indicated by the environmental information map M3. When it is determined as No in Step S6, the processing proceeds to Step S7, and a computing loop starts for the environmental information maps M2, M3, M4 as another map. On the other hand, when it is determined as Yes in Step S6, that is, when it is determined that the edge E overlaps with the important information, the processing proceeds to Step S12 to update the weight for the edge E and then proceeds to Step S11.

In Step S8, the weight is newly calculated for the environmental information maps M2, M3, M4. In Step S9, the weight for each edge E in the traveling route map M1 is updated. Subsequently in Step S10, the computing loop for the environmental information maps M2, M3, M4 as another map ends. In Step S11, the computing loop for each edge E in the traveling route map M1 ends, and a series of control ends.

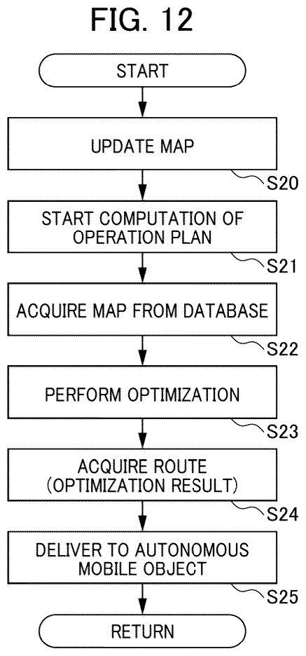

FIG. 12 is a flowchart showing steps of optimizing the traveling route. More specifically, the user checks the result of weighting of each edge forming the traveling route, and thereafter, can reflect the traveling route based on the weighting result to optimize the traveling route. In Step S20, the maps are updated in consideration of the weighting result shown in the flowchart of FIG. 11. In Step S21, computation of an operation plan starts, and in Step S22, the maps are acquired from the database. Subsequently in Step S23, optimization is performed, and as a result of optimization, a new route is acquired. Then, in Step S25, the route is delivered to the autonomous mobile object 1, and a series of control ends.

With this configuration, the user can grasp the causal relationship between the traveling route selection result and the environmental information, and can use such a relationship as a material for consideration taken for selecting a traveling route with a higher operation efficiency. For example, selection of the traveling route can be optimized by performing maintenance on a road surface in order to prevent interference with traveling of the autonomous mobile object, improving the status of reception of the radio wave from the satellite positioning system, or the like. Further, for example, an obstacle (person, other vehicles, or the like around a worker or the like) is displayed on an occupancy grid map, and therefore, if such a moving obstacle approaching the route along which the autonomous mobile object travels could be confirmed, an alert or the like can be issued to the moving obstacle including the person around the worker or the like.

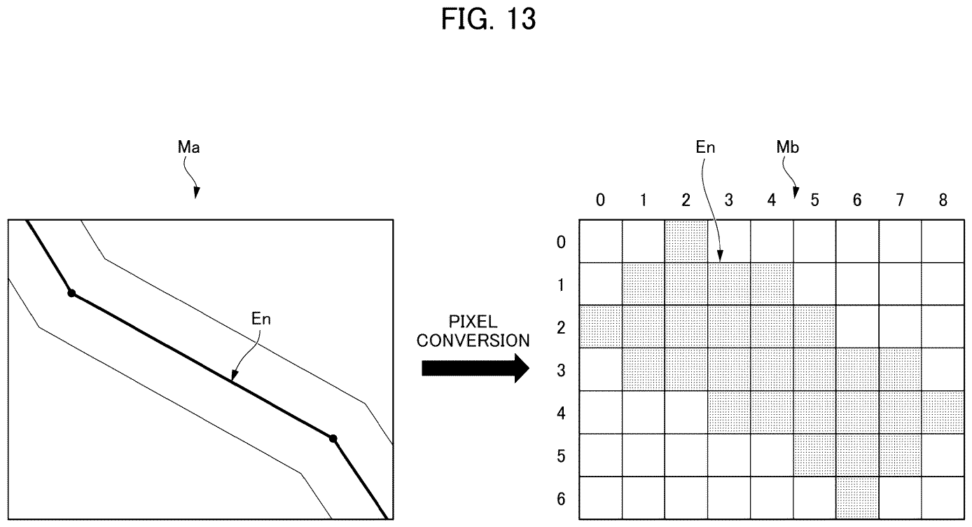

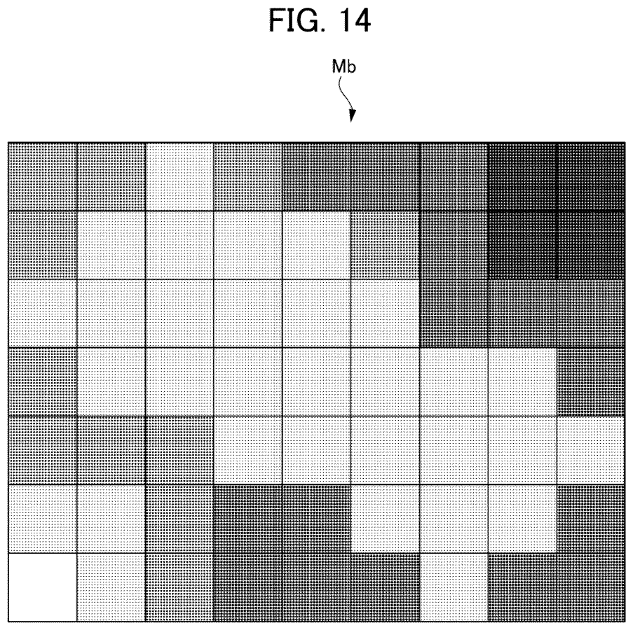

FIG. 13 is a schematic diagram showing steps of converting a traveling route map Ma into a pixel image Mb. FIG. 14 is one example of the pixel image Mb on which the environmental information maps M2, M3, M4 are superimposed. FIG. 13 shows a state in which the pixel image Mb is obtained by the pixel processor 24 performing image processing on one edge En in units of pixels. The edge En is converted into a pixel coordinate array (portion hatched with dots in the figure) using information on the coordinates of the node N and the width (width of the traveling route) of the edge E in a file in a JavaScript Object Notation (JSON) formant.

In the pixel image Mb shown in FIG. 14, one value indicating the weight is stored in each pixel around the edge En. The environmental information maps M2, M3, M4 have different physical quantities such as the stoppage time of the autonomous mobile object 1 and the GNSS radio wave intensity. The environmental information for the environmental information map, which is acquired using the external sensor of the autonomous mobile object 1 in the area (range) defined in the traveling route map M1 including the nodes and the edges, is transmitted at predetermined intervals from the autonomous mobile object 1 to the information collector 21 of the server S. The environmental information is autonomous mobile object work (traveling) area information acquired using the external sensor attached to the autonomous mobile object 1. Examples of the external sensor may include, for example, a camera, LiDAR, a radar, a sonar, and the like. The camera is, for example, a digital camera using an imaging element such as a CCD or a CMOS, and outputs, to the processor 31, image data obtained by imaging the periphery of the autonomous mobile object 1.

The environmental information acquired by the external sensor is transmitted from the memory 32 of the vehicle body to the server S, and the environmental information maps M2, M3, M4 are created in the server S. Specific examples of the environmental information may include the stoppage time information (for example, a stoppage time or the like due to congestion caused when other vehicles, pedestrians, or the like are present) upon movement of the autonomous mobile object 1, the GNSS radio wave intensity received by the GNSS receiver 30, occupancy grid information which is information indicating on which point (grid) on the above-described traveling route map an obstacle detected using an optical sensor such as LiDAR or a camera is located, and the like.

The environmental information has the different physical quantities as described above, and these quantities are seconds (s) for the stoppage time and RSSI (dBm) for the GNSS reception status. The environmental information map includes grips (each pixel) divided at predetermined intervals, and each pixel in the environmental information map holds the environmental information. For example, as the way to hold the environmental information, one pixel saves [the minimum value, the maximum value, a reference value] ([V_1, V_u, V_m]) for a particular physical quantity (for example, [0, 600, 0] for the waiting time,

[−90, −50, −65] for the RSSI).

One method for expressing, as the weight, each of the environmental information maps M2, M3, M4 on one synthetic map MG is a method using the minimum value, maximum value, and reference value of each value in the environmental information map. As one example, in the environmental information map M2, each pixel has [the minimum value, the maximum value, the reference value] for the stoppage time. For example, in the case of a value [0 (minimum value), 600 (maximum value), 0 (reference value)], the environmental information map M2 is standardized using the maximum value (255) of 256 levels (0 to 255) of the color tone of RGB in order to convert the environmental information map M2 into the RGB image format. By standardization, [0, 600, 0] above is represented by a value in the range of 0 to 255, and in the example described above, can be expressed as [0, 255, 0].

As described above, each pixel in the environmental information map M2 has [the minimum value, the maximum value, the reference value] after standardization. Similarly, the other environmental information maps M3, M4 can also be converted into the RGB image format. Note that the size of each pixel can be arbitrarily changed, and for example, a data communication speed can be increased by increasing the size of the pixel and decreasing the resolution of the environmental information map as necessary.

The contribution of each of the environmental information maps M2, M3, M4 to the synthetic map MG, that is, how much the information indicated by each of the environmental information maps M2, M3, M4 affects weighting of the edge E, is expressed by the ratio of the standard deviation of the information indicated by each of the environmental information maps M2, M3, M4, and the total thereof is 1. The contribution of each of the environmental information maps M2, M3, M4 may be set in advance by the user U, be automatically set in the controller 20 depending on the situation, or be arbitrarily changed using the weight changer 5 by the user U.

Weighting when the synthetic map MG is created includes weighting of each environmental information map forming the synthetic map MG, and weighting of each edge E displayed on the synthetic map MG shown in FIG. 9. The weight changer 5 can arbitrarily change one or both of the weight for each environmental information map and the weight for each edge E displayed on the synthetic map MG. On the synthetic map MG, the weight for each environmental information map when the synthetic map MG is created may be displayed in the form of a numerical value, a color, shade of color, or the like.

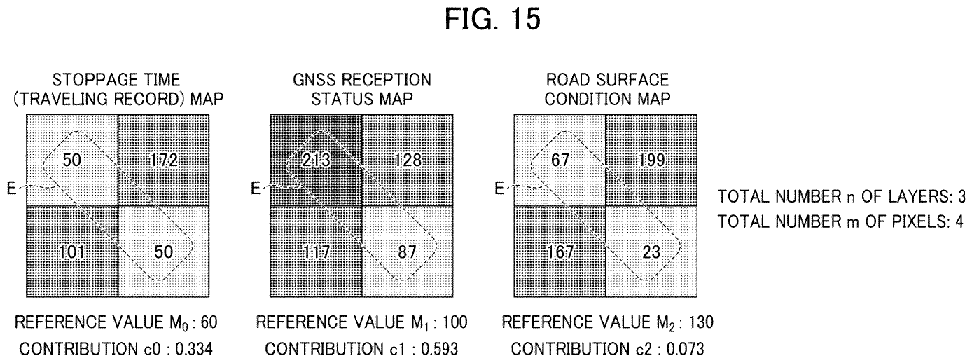

FIG. 15 is a conceptual diagram showing a computing method for obtaining the weight for the edge E extending over four pixels. This diagram shows the stoppage time (traveling record) map M2, the GNSS reception status map M3, and the road surface condition map M4 as three layers to be superimposed on the traveling route map M1 to create the synthetic map MG. For each map, the reference value and the contribution are set. The four pixels are located at the same coordinates on each map, and 256 levels of pixel values of 0 to 255 indicating the weight for each pixel are set for these pixels.

For computation of the weight for the edge E, the reference value is subtracted from each pixel value on the pixel coordinate array, the solution thereto is divided by 255, and then, the average of the values for the four pixels is obtained and multiplied by the first contribution. This process is performed on each map. Then, three calculated weights are added up, thereby obtaining a desired weight for the edge E in the synthetic map MG.

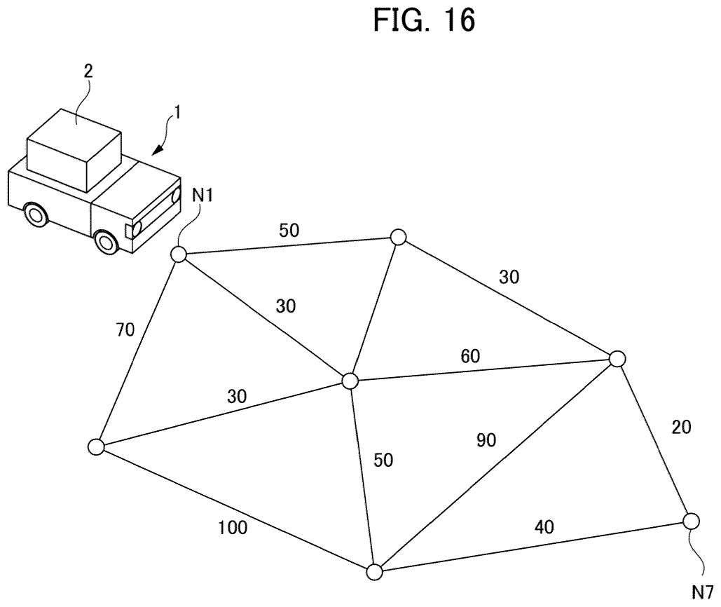

FIG. 16 is a schematic diagram showing a modification of the synthetic map MG. For each edge E in the synthetic map MG, a number indicating the weight for the edge E may be displayed in the vicinity of such an edge E. According to such a display method, the user U can easily grasp the magnitude of the weight set for each edge E. The weight indicated by the number may be displayed in combination of the weight indicated by the color information.

As described above, the traveling route display method according to the present invention is the traveling route display method for displaying the plurality of traveling routes connecting the point of departure N1 and the destination N7 of the autonomous mobile object 1 operated within the work area A, which includes the step T1 of the traveling route map generator 22 generating the traveling route map M1 including the nodes N and the edges E, the step T2 of the information collector 21 collecting the environmental information, the step T3 of the environmental information map generator 23 generating the environmental information maps M2, M3, M4 from which the environmental information can be visually recognized, the step T4 of the map synthesizer 26 superimposing the environmental information maps M2, M3, M4 on the traveling route map M1 to generate the synthetic map MG from which the weight set for the edge E according to the level of the environmental information can be visually recognized, and the step T5 of the display 4 displaying the synthetic map MG. Thus, the user U can visually recognize the weight set for each edge E in the traveling route map M1, and therefore, the user U can visually recognize how much and which one of the environmental information affects selection of the traveling route. As a result, the user can grasp the causal relationship between the traveling route selection result and the environmental information, and can use such a relationship as a material for consideration taken for selecting a traveling route with a higher operation efficiency.

The server S as an information processing device according to the present embodiment can build an information service system together with the display 4 as a display device provided for the mobile terminal 3 or the like. More specifically, the information service system has the server S and the display 4 communicably connected to the server S, the display 4 is capable of displaying the plurality of traveling routes connecting the point of departure N1 and the destination N7 of the autonomous mobile object 1 operated within the work area A, the traveling route information stored in the server S and the information including the physical quantities of the environmental information in the work area A are converted into the image data displayed in colors, and such image data can be displayed on the display 4. The information service system includes the autonomous mobile object 1 and the server S communicable with the autonomous mobile object 1. The display 4 that displays the image data includes the liquid crystal display and the like provided for the mobile terminal 3.

According to the information service system, the server S can set the weight for the traveling route according to the contribution of each piece of environmental information on the traveling route, recalculate the weight according to the contribution newly input by the user according to the displayed image data, and reselect the traveling route according to the recalculated weight. As a result, not only can the user grasp the causal relationship between the traveling route selection result and the environmental information, but also the user can quickly change the traveling route. Thus, the operation efficiency of the autonomous mobile object can be enhanced.

The form of the autonomous mobile object and the number thereof, the location where the map database is stored, the configuration of the traveling route map, the type of environmental information and the number thereof, the method for collecting the environmental information, the method for generating the environmental information map and the form thereof, the form of the synthetic map, the form of the mobile terminal, and the like are not limited to those of the embodiment above, and various changes can be made thereto.

### EXPLANATION OF REFERENCE NUMERALS

1: Autonomous Mobile Object, 3: Mobile Terminal, 4: Display, 5: Weight Changer, 21: Information Collector, 22: Traveling Route Map Generator, 23: Environmental Information Map Generator, 24: Pixel Processor, 26: Map Synthesizer, A: Work Area, M1: Traveling Route Map, M2, M3, M4: Environmental Information Map, MG: Synthetic Map, N (N1 to N7): Node, N1: Point of Departure, E (E1 to E12): Edge, N7: Destination, T1: First Step, T2: Second Step, T3: Third Step, T4: Fourth Step, T5: Fifth Step, U: User

What is claimed is:

1. A traveling route display method for displaying a traveling route connecting a point of departure and a destination of an autonomous mobile object operated within a work area, comprising:
a first step of generating, by a traveling route map generator, a traveling route map including a node and an edge;
a second step of collecting, by an information collector, at least environmental information acquired using an external sensor attached to the autonomous mobile object;
a third step of generating, by an environmental information map generator, an environmental information map from which the environmental information is visually recognizable;
a fourth step of superimposing, by a map synthesizer, at least one environmental information map on the traveling route map to generate a synthetic map from which a weight set for the edge according to a level of the environmental information is visually recognizable; and
a fifth step of displaying, on a display, the synthetic map.

2. The traveling route display method according to claim 1, wherein the weight set for the edge is arbitrarily changeable by a weight changer.

3. The traveling route display method according to claim 1, wherein the environmental information map includes a color representation based on shade of color.

4. The traveling route display method according to claim 3, wherein the environmental information map is displayed in RGB colors.

5. The traveling route display method according to claim 3,
the environmental information map being a pixel image indicating the level of the environmental information, further comprising:
a step of converting, by a pixel processor, the environmental information into the pixel image.

6. The traveling route display method according to claim 5, wherein a resolution of the environmental information map is changeable by changing a size of a pixel forming the pixel image.

7. The traveling route display method according to claim 1, wherein the weight is displayed in a form of a number on the synthetic map.

8. The traveling route display method according to claim 2, wherein the display and the weight changer are provided in a mobile terminal to be operated by a user.

9. An information service system comprising: an information processing device and a display communicably connected to the information processing device,
wherein the display is capable of displaying a traveling route connecting a point of departure and a destination of an autonomous mobile object operated within a work area,
information on the traveling route stored in the information processing device and information including a physical quantity of environmental information in the work area are converted into image data displayed in colors, and
the image data is displayable on the display.

10. The information service system according to claim 9, wherein
the information processing device sets a weight for the traveling route according to a contribution of each piece of environmental information on the traveling route,
recalculates the weight according to a contribution newly input by a user according to the displayed image data, and reselects the traveling route according to the recalculated weight.
